(19) United States
(12) Patent Application Publication
(10) Pub. No.: US 2026/0095232 A1
(43) Pub. Date: Apr. 2, 2026

(54) NEAR-FIELD AND FAR-FIELD BASED BEAMFORMING SWITCHING

(71) Applicant: Apple Inc., Cupertino, CA (US)

(72) Inventors: Ankit Bhamri, Haar (DE); Dawei Zhang, Saratoga, CA (US); Haitong Sun, Saratoga, CA (US); Wei Zeng, Saratoga, CA (US); Weidong Yang, San Diego, CA (US); Hong He, San Jose, CA (US); Oghenekome Oteri, San Diego, CA (US)

(73) Assignee: Apple Inc., Cupertino, CA (US)

(21) Appl. No.: 19/312,067

(22) Filed: Aug. 27, 2025

Related U.S. Application Data
(60) Provisional application No. 63/700,517, filed on Sep. 27, 2024.

(51) Int. Cl. H04B 7/06; H01Q 3/34; H04B 17/318; H04B 17/336

(52) U.S. Cl. CPC H04B 7/06952; H04B 7/0617; H04B 17/328; H04B 17/336; H01Q 3/34

(57) ABSTRACT

The present application relates to devices and components including apparatus, systems, and methods for determining and/or implementing near-field operation or far-field operation for beamforming.

### CROSS-REFERENCES TO RELATED APPLICATIONS

This application claims the benefit to U.S. Provisional Application No. 63/700,517, filed Sep. 27, 2024, entitled “Near-Field and Far-Field Based Beamforming Switching,” the disclosure which is incorporated by reference in its entirety and for all purposes.

### TECHNICAL FIELD

The present application relates to the field of wireless technologies and, in particular, to switching between near-field operation and far-field operation for beamforming.

### BACKGROUND

Third Generation Partnership Project (3GPP) networks have developed to implement beamforming for communication between network elements. For example, a base station may generate a beam to transmit a signal to a user equipment (UE). The beamforming can allow for signals to be directed in a particular direction toward a particular network element rather than the signal being broadcast in all directions. This beamforming can improve the operation of the networks.

### BRIEF DESCRIPTION OF THE DRAWINGS

FIG. 1 illustrates a network environment in accordance with some embodiments.

FIG. 2 illustrates a user equipment (UE) in accordance with some embodiments.

FIG. 3 illustrates a network device in accordance with some embodiments.

FIG. 4 illustrates a table of example near-field range determinations in accordance with some embodiments.

FIG. 5 illustrates an example beamforming arrangement in accordance with some embodiments.

FIG. 6 illustrates representations of example normalized array gains in the physical space in accordance with some embodiments.

FIG. 7 illustrates a table of parameters for an example simulation scenario in accordance with some embodiments.

FIG. 8 illustrates an example arrangement for the example simulation scenario in accordance with some embodiments.

FIG. 9 illustrates an example normalized beamforming gain representation for carrier frequency of 7 gigahertz (GHz) in accordance with some embodiments.

FIG. 10 illustrates an example normalized beamforming gain representation for carrier frequency of 15 GHz in accordance with some embodiments.

FIG. 11 illustrates an example normalized beamforming gain per subcarrier index representation for carrier frequency of 7 GHz and bandwidth (BW) size of 100 megahertz (MHz) in accordance with some embodiments.

FIG. 12 illustrates an example normalized beamforming gain per subcarrier index representation for carrier frequency of 15 GHz and BW size of 100 MHz in accordance with some embodiments.

FIG. 13 illustrates an example normalized beamforming gain per subcarrier index representation for carrier frequency of 7 GHz and bandwidth size of 400 MHz in accordance with some embodiments.

FIG. 14 illustrates an example normalized beamforming gain for sub-bands comparison representation in accordance with some embodiments.

FIG. 15 illustrates example arrangements of the sixth approach in accordance with some embodiments.

FIG. 16 illustrates an example arrangement of the second option of the sixth approach in accordance with some embodiments.

FIG. 17 illustrates an example procedure for determining whether near-field operation or far-field operation is to be implemented for beamforming in accordance with some embodiments.

FIG. 18 illustrates an example procedure for determining whether to initiate a switch between near-field operation and far-field operation in accordance with some embodiments.

FIG. 19 illustrates an example procedure for implementing near-field operation or far-field operation for beamforming in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

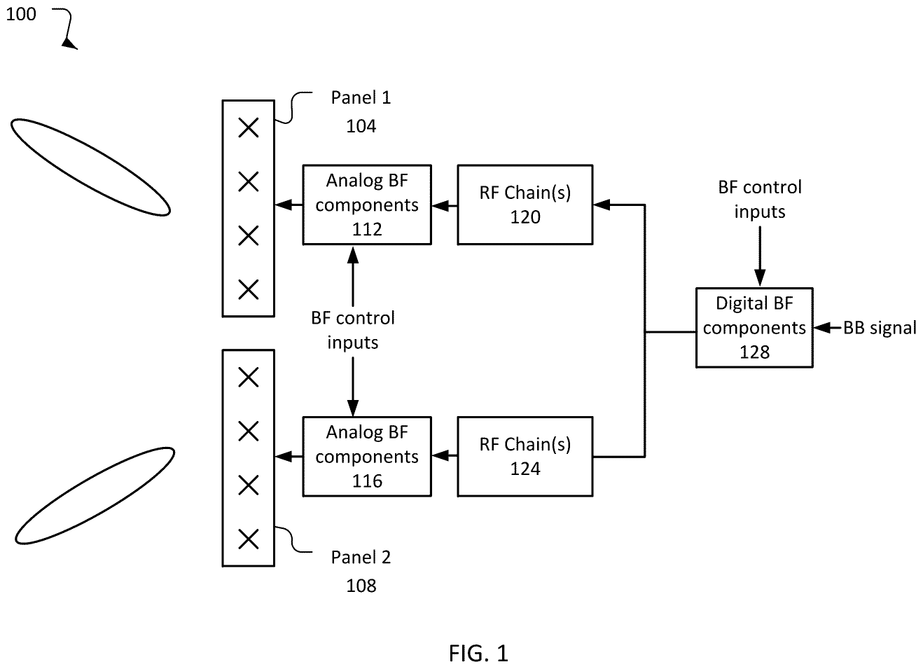

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5^{th} Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

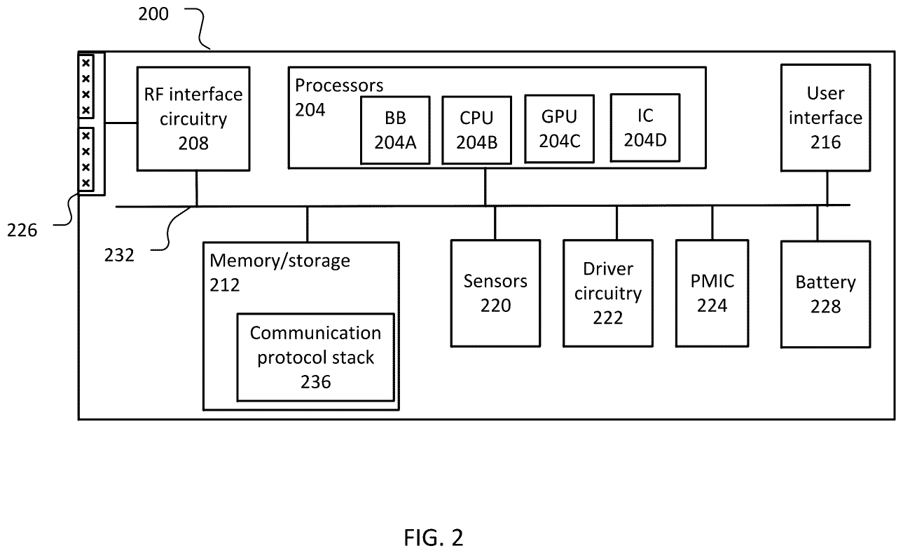

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. In some embodiments, processors 204 may include RF interface circuitry 208. The block diagram of FIG. 2 is intended to show a high-level view of some of the components of the UE 200. However, some of the components shown may be omitted, additional components may be present, and different arrangement of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform near-field operation or far-field beamforming operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various perform near-field operation or far-field beamforming operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals. The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

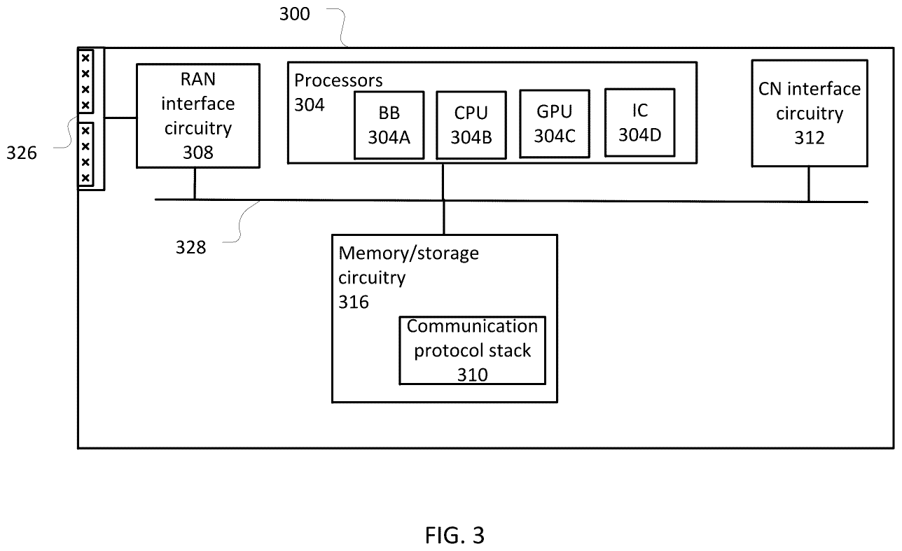

FIG. 3 illustrates a network device 300 in accordance with some embodiments. The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5th Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

Beamforming has become common place in wireless communication networks, such as for carrying transmissions between user equipments (UEs) and base stations. However, the distance between the UEs and the base stations can affect the quality and/or operability of beamforming. As such, near-field operation and far-field operation have developed for beamforming for addressing the issues caused by different distances between the UEs and the base stations. Ensuring that the proper one of near-field operation or far-field operation is being utilized for communicating with a UE can ensure that beamformed transmissions are successful. Approaches described herein can facilitate switching between near-field operation and far-field operation to facilitate effective beamformed transmissions.

Near-field range determination may be utilized for determining whether near-field operation or far-field operation is to be utilized for a UE. For uniform planar array (UPA), near field range can be determined by

$$R = \frac{2 {f}_{c} {D}^{2}}{c} , where D = \sqrt{{L}_{1}^{2} + {L}_{2}^{2}} ,$$

and L₁=0.8AN and L₂=0.8λM. Further, f_{c} is the carrier frequency and c is speed of light, D is the antenna aperture (diagonal of the array), L₁ is the antenna array vertical dimension and L₂ is the antenna array horizontal dimension, and N is the number of elements in vertical domain and M is the number of elements in horizontal domain.

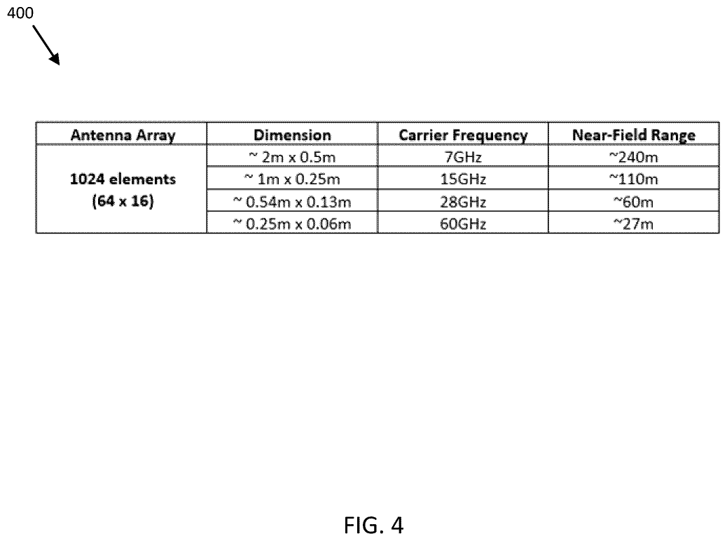

FIG. 4 illustrates a table 400 of example near-field range determinations in accordance with some embodiments. In particular, the table 400 illustrates some example near-field range distances determined in accordance with the equation above for determining near-field range distances.

For new bands such as in frequency range 3 (FR3) (7 gigahertz (GHz)-15 GHz bands) and with enhanced licensed-assisted access (ELAA) in frequency range 2 (FR2), near-field range is expected to be quite long and cannot be ignored. Sixth generation (6G) systems may support operation in both near-field and far-field regions.

A beamforming issue may exist in near-field. For an extremely large array of antennas operating in wide-band, essentially the beamforming gain/directivity splits in multiple directions, depending on the frequency within the wide-band and as a result the expected/desired beamforming gain at intended UE's location is achieved. In near-field region, due to spherical wave, the beamforming gain is not only split at different points/phases, but also at different distance from the Tx/Rx

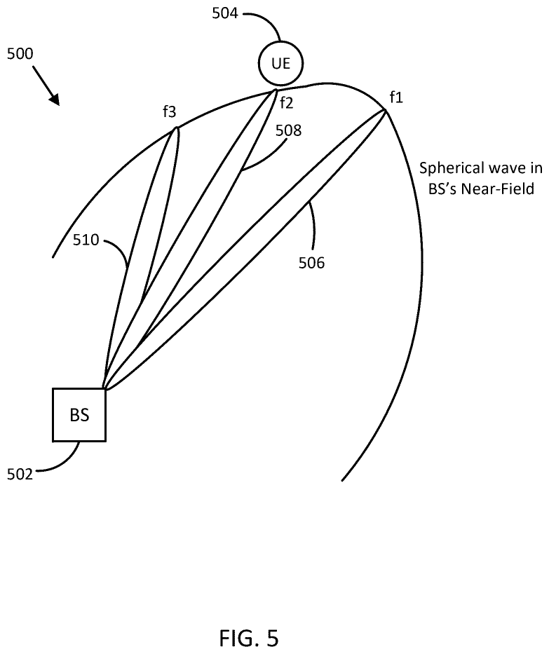

FIG. 5 illustrates an example beamforming arrangement 500 in accordance with some embodiments. The arrangement 500 illustrates an example of beamforming gain/directivity splits that may occur in near-field.

The arrangement 500 includes a base station 502. The base station 502 may include one or more of the features of the base station 108 (FIG. 1) and/or the network device 300 (FIG. 3). The arrangement 500 further includes a UE 504. The UE 504 may include one or more of the features of the UE 104 (FIG. 1), the UE 106 (FIG. 1), and/or the UE 200 (FIG. 2).

The base station 502 is illustrated transmitting a signal to the UE via beamforming. The base station 502 is transmitting a single beam. However, the single beam may split into different points and different distances on a spherical wave at different frequencies within a wideband. For example, the arrangement 500 shows a first frequency beam split 506, a second frequency beam split 508, and a third frequency beam split 510 of the single beam.

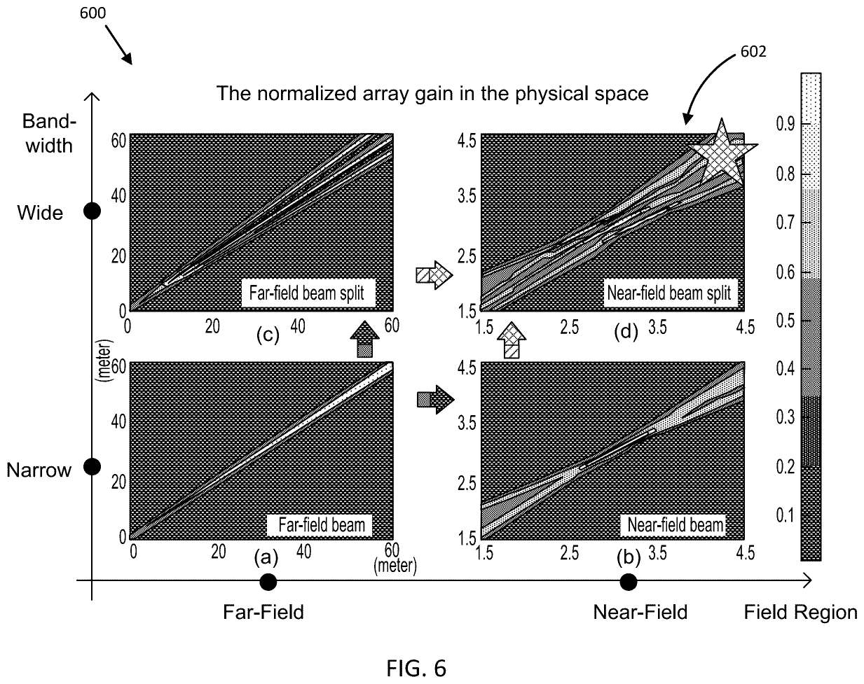

FIG. 6 illustrates representations 600 of example normalized array gains in the physical space in accordance with some embodiments. In particular, the representations 600 include representations for normalized array gain for combinations of narrow and wide bandwidth, and far-field and near-field field regions. As can be seen from representation 602 (the upper right representation), the beam experiences significant beamforming gain splitting at wide band width and near-field, which can be undesirable.

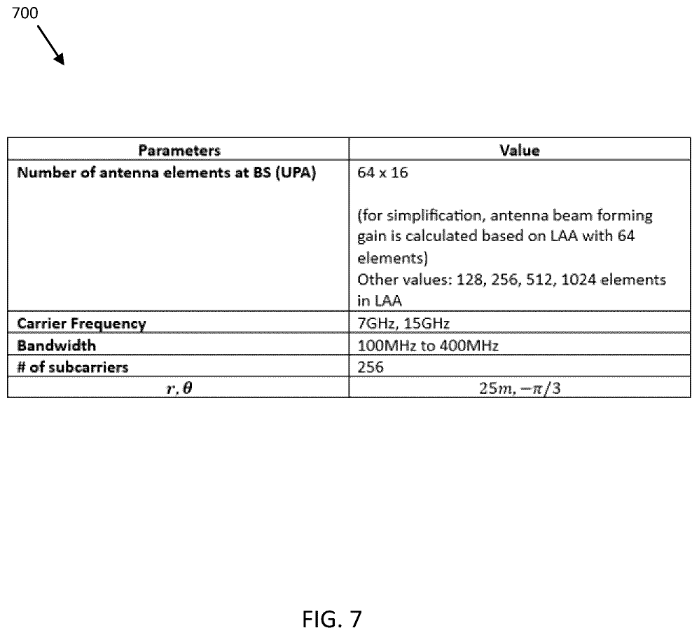

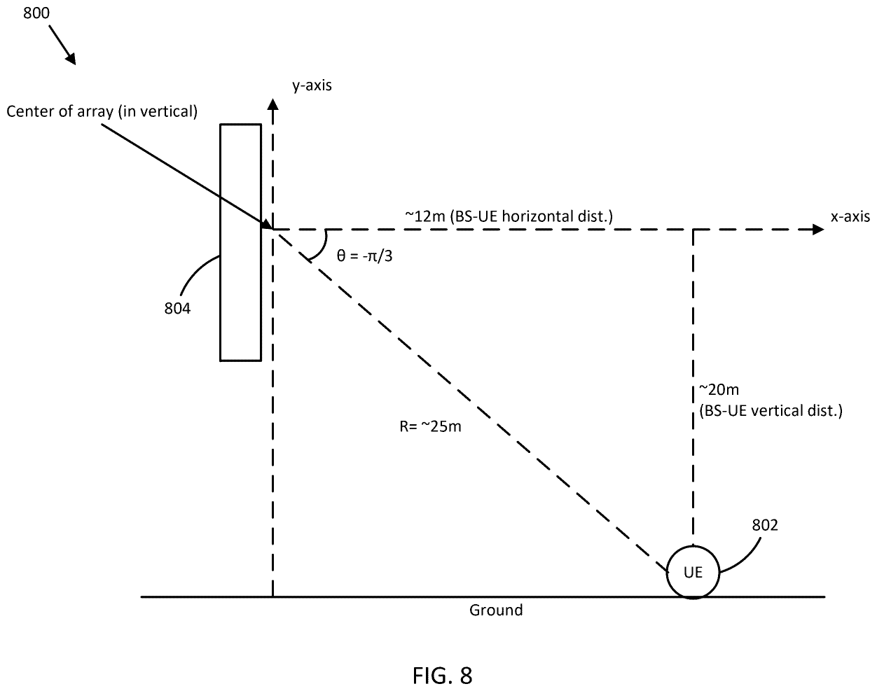

FIG. 7 and FIG. 8 illustrate a simulation scenario/assumption. In particular, FIG. 7 illustrates a table 700 of parameters for an example simulation scenario in accordance with some embodiments. FIG. 8 illustrates an example arrangement 800 for the example simulation scenario in accordance with some embodiments.

The arrangement 800 includes a UE 802. The UE 802 may include one or more of the features of the UE 104 (FIG. 1), the UE 106 (FIG. 1), and/or the UE 200 (FIG. 2). Further, the arrangement 800 includes an antenna array 804 of a base station. The arrangement 800 illustrates positional relationships between the antenna array 804 and the UE 802 for the simulation scenario. The table 700 illustrates values for parameters of the simulation scenario represented by the arrangement 800.

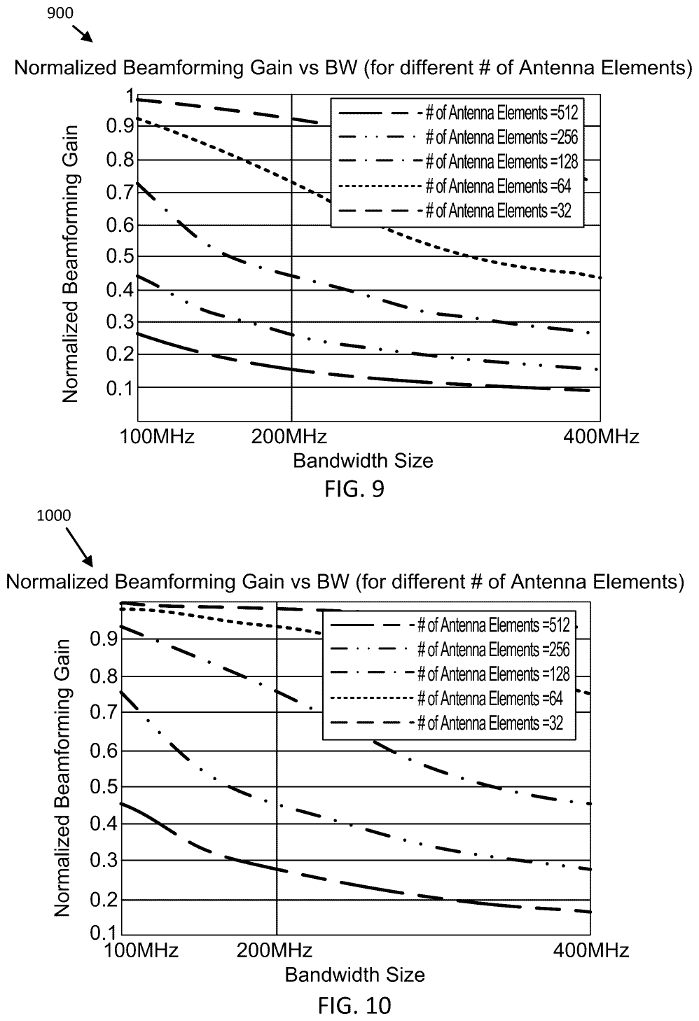

FIG. 9 and FIG. 10 illustrate beamforming representations in near-field. In particular, FIG. 9 illustrates an example normalized beamforming gain representation 900 for carrier frequency of 7 GHz in accordance with some embodiments. FIG. 10 illustrates an example normalized beamforming gain representation 1000 for carrier frequency of 15 GHz in accordance with some embodiments.

As the number of antenna elements increase, the impact of near-field on beamforming can be seen for a UE at a given location. Due to increasing impact of beam squinting with increasing number of antennas (i.e., more prominent near-field impact) there is a significant degradation in beamforming gain.

Alternatively, as a UE is closer and closer to the BS, beamforming gain degradation due to the near-field field impact is more prominent. Basically, for a fixed location, it may be within near-field or far-field region depending on the number of antenna elements. For example, for a number of antenna element 32 with center frequency (CF) of 15 GHz, there is less than 90% beamforming loss, so it can be assumed that this is in far-field.

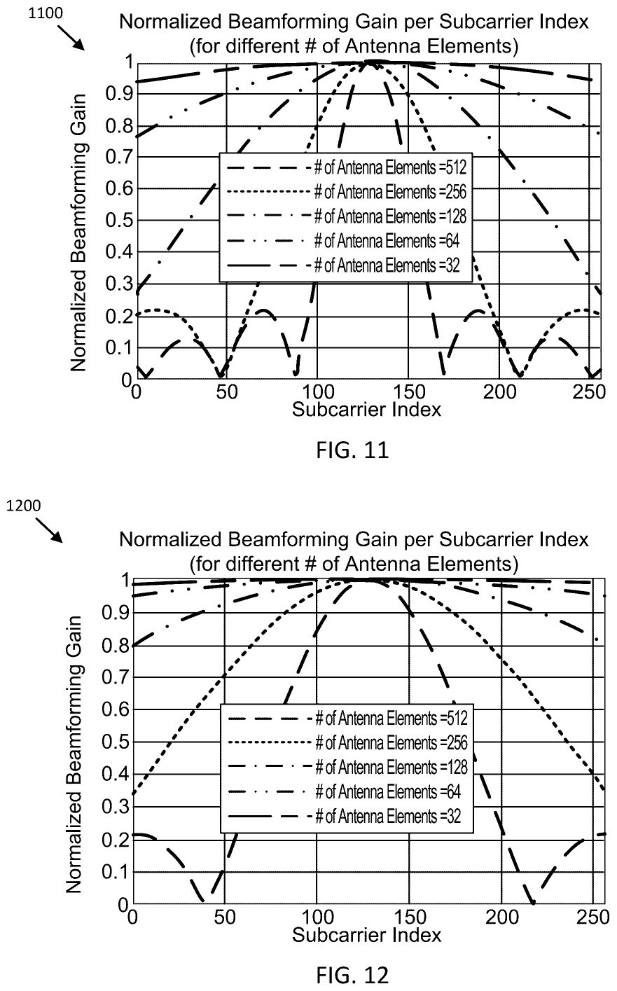

FIG. 11 and FIG. 12 illustrate additional beamforming representations in near-field. In particular, FIG. 11 illustrates an example normalized beamforming gain per subcarrier index representation 1100 for carrier frequency of 7 GHz and bandwidth (BW) size of 100 megahertz (MHz) in accordance with some embodiments. FIG. 12 illustrates an example normalized beamforming gain per subcarrier index representation 1200 for carrier frequency of 15 GHz and BW size of 100 megahertz (MHz) in accordance with some embodiments.

Another measure of the beamforming performance degradation in the near-field compared to far-field is significant degradation on the carriers that are farther away from the central frequency carrier within a band, as analyzed in FIG. 11 and FIG. 12.

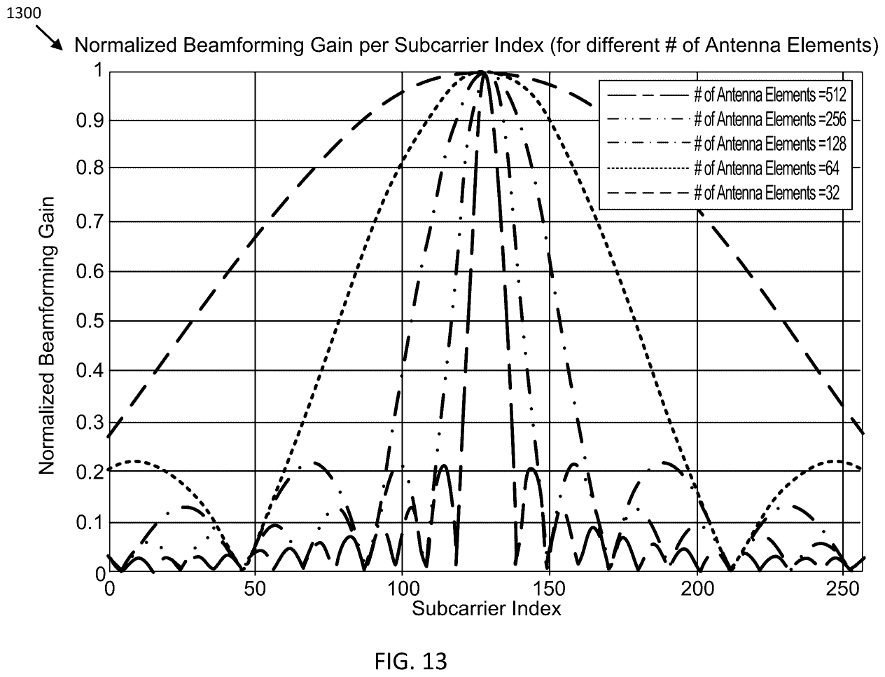

Degradation is even worse in near field when combined with wideband allocation, as analyzed in FIG. 13. For example, FIG. 13 illustrates an example normalized beamforming gain per subcarrier index representation 1300 for carrier frequency of 7 GHz and bandwidth size of 400 MHz in accordance with some embodiments. As can be seen, the degradation shown in the representation 1300 is greater than the degradation of the representation 1100 and the representation 1200 due to the larger bandwidth size.

Based on the analysis and literature review above, it is clear that the operating condition for UE in terms of channel quality, channel state information (CSI), and beamforming, vary quite a lot between the near-field region and the far-field region. Therefore, in order to have a switch when UE is operating in near-field and far-field region, new methods, measurements and signaling are presented herein to address these issues.

From the UE point of view, it may be a simplified and cleaner design, if the UE is aware about operation in near-field or far-field region and performs measurements, reporting and maintaining beams only specific to that region. Otherwise, the UE may need to maintain large number of beams (TCI) and perform corresponding measurements/reporting.

Herein disclosed are approaches for addressing near-field and far-field switching issues. The approaches may include to determine conditions to identify if the UE needs to operate in near-field or far-field, UE-initiated triggering for switching between near-field and far-field, field-specific TCI states and configuration, and near-field and far-field specific CSI resources, beam measurements and reporting. Embodiments described herein may implement one or more of these approaches.

Beamforming approach direction are presented herein. For near-field determination, according to a first approach (which may be referred to as approach 1), a criteria to determine whether a UE is in the near-field region or far-field region is defined, wherein the criteria may be preconfigured to UE as described in the following.

Sub-band layer 1 (L1) reference signal received power (RSRP) L1_{RSRP}_{ₙ} for sub-band n (or similar metric) may be determined corresponding to a wideband channel state information-reference signal resource indicator (CRI). For example, a single beam for entire allocated bandwidth. For each sub-band n, a ratio rₙ may be calculated:

$$\frac{L {1}_{{RSRP}_{n}}}{L {1}_{{RSRP}_{m}}} ,$$

where L1_{RSRP}_{ₘ} corresponds the middle sub-band m. Sub-band m may typically be the one with the highest beamforming gain.

In order to determine, whether the UE is in the far-field region may be determined whether the ratio is bigger than a threshold. For example, rₙ>R, where R is the pre-configured threshold. Essentially, if the beamforming gain of sub-bands compared to middle sub-band(s) is much lower, then it can be assumed that the UE is in the near-field region.

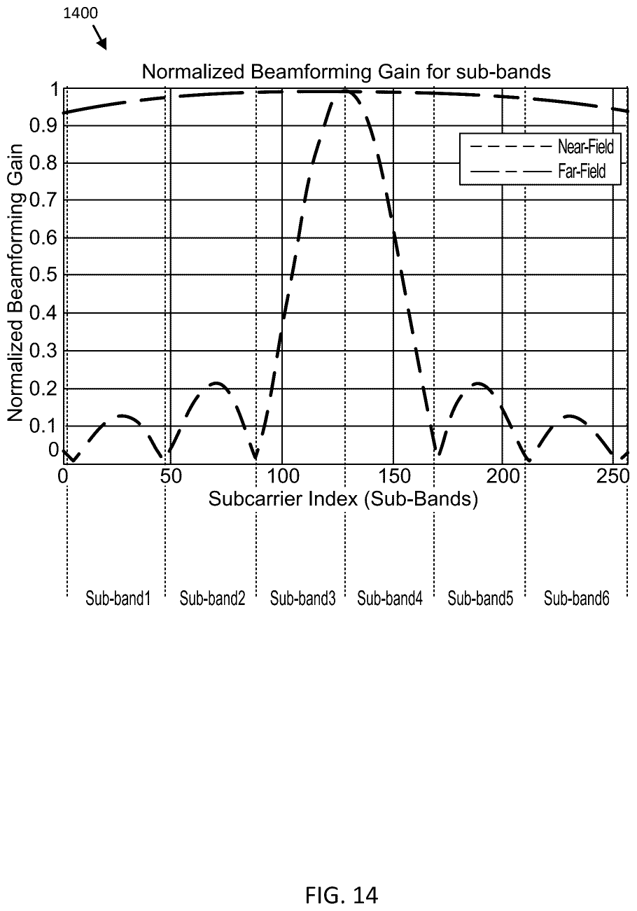

FIG. 14 illustrates an example normalized beamforming gain for sub-bands comparison representation 1400 in accordance with some embodiments. In the representation 1400, two scenarios are illustrated. A first scenario (which may be referred to as scenario 1) represents far-field. For far-field scenario determination, it can be observed that for the 6 sub-bands within the bandwidth allocation, the normalized beamforming gain across all sub-bands is with 10% difference.

A second scenario (which may be referred to as scenario 2) represents near-field. For near-field scenario determination, it can be observed that for the 6 sub-bands within the bandwidth allocation, the normalized beamforming gain across all sub-bands has a huge difference of approximately 90%.

A UE-triggered switch may be implemented in embodiments. According to a second approach (which may be referred to as approach 2). UE-triggered switch between near-field and far-field may be considered. The UE may initiate a trigger to the network (such as via a base station) to perform switching from near-field to far-field or from far-field to near-field based on a pre-configured event trigger.

The event trigger for switch from far-field to near-field may be based on degradation of sub-band layer 1 reference signal received power (L1-RSRP) on the sub-bands (as they are farther and farther from the middle sub-bands) for set of measurements within a fixed duration that may be configured by the network. In some embodiments, the event may be triggered if there are multiple measurements (exact number could be pre-configured) within the fixed duration for which the sub-band L1-RSRP degradation is determined.

The event trigger for switch from near-field to far-field may be based on sub-band L1-RSRP on the sub-bands above a pre-defined threshold (i.e., consistent L1-RSRP across the sub-bands and ration above threshold) for set of measurements within a fixed duration that may be configured by the network. In some embodiments, the event is triggered if there are multiple measurements (exact number could be pre-configured) within the fixed duration for which the sub-band L1-RSRP degradation is determined.

According to a third approach (which may be referred to as approach 3), for where supporting UE-triggered switch between near-field and far-field is considered, UE may report back a binary information to indicate whether it needs to switch from current field to different field (toggle bit based reporting). In one alternative, if currently the UE is operating in near-field region and if the reported quantity for this feedback is “0”, then the network may assume no switch is needed. If the reported quantity for this feedback is “1”, then the network may assume that UE recommends to switch to different field. Accordingly, the network may determine whether the reported feedback is “0” or “1,” and determine based on the feedback whether the UE recommends switching.

In another alternative, if no event switch needs to be triggered, then UE may simply not report on the configured uplink resource for this UE-triggered reporting and if event switch needs to be triggered, then only UE may report on the configured uplink resource for this UE-triggered reporting event. Accordingly, the network may determine whether configured uplink resource includes a report from the UE, and determine based on whether a report is received whether the UE recommends switching.

In some embodiments, a network-indicated switch may be implemented. According to a first option of a fourth approach (which may be referred to as approach 4-1), the network may either explicitly signal for the UE to switch from current field operation to a different field (i.e., switch between near-field and far-field). The explicit signal may be radio resource control (RRC) configured, medium access control (MAC) control element (CE) activated or downlink control information (DCI)-based. For example, the network may transmit an RRC signal, an MAC CE signal, or a DCI signal to the UE that indicates whether the UE is to switch between near-field operation and far-field operation. In some embodiments, such switch may be signaled by network based on explicit trigger/recommendation from the UE. In other embodiments, such switch may be signaled by the network based on received measurement reports from a UE, such sub-band L1-RSRP.

According to a second option of the fourth approach (which may be referred to as approach 4-2), the network may implicitly signal the UE to switch from current field operation to a different field (i.e., switch between near-field and far-field). The implicit signal may include one or multiple of RRC reconfiguration of transmission configuration indicator (TCI) states for a different field than the current field, MAC CE activating TCI states corresponding to a different field than the current field, and/or DCI indicating TCI state corresponding to a different field than the current field.

Field-specific TCI states may be implemented in some embodiments. According to fifth approach (which may be referred to as approach 5), a separate/dedicated set of TCI states may be configured to UE corresponding to near-field and far-field region. The set corresponding to near-field may be applied when the switch to near-field is triggered and the set corresponding far-field may be applied when the switch to far-field is triggered.

In a first block, a set of TCI states corresponding to near-field may be RRC configured and a set of TCI states corresponding to far-field may also be RRC configured. In a second block, MAC CE may activate a sub-set of TCI states from either near-field or far-field, depending upon which field is currently applied/triggered. In a third block, DCI may indicate one or more TCI states from the activated sub-set. In a fourth block, the network and/or the UE may trigger switch to different field. In a fifth block, a MAC CE may activate a sub-set of TCI states from the set that is now according to new field.

According to a first option of the fifth approach (which may be referred to as approach 5-1), a single unified TCI states may be configured that may near-field specific TCI states, far-field specific TCI states, or joint TCI states for near-field and far field. For near-field specific TCI states, these states may be applied for further MAC CE activation only when UE is configured to be operating in near-field region. For far-field specific TCI states, these states may be applied for further MAC CE activation only when UE is configured to be operating in far-field region. For joint TCI state for near-field and far-field, these states may be applied regardless of near-field and far-field region and can be jointly applied to either field.

In some embodiments, CSI resource and report may be implemented. According to a first option of a sixth approach (which may be referred to as approach 6-1), a CSI resource set may contain multiple resources, where the resources may be associated with measurements only in near-field region or far-field region. For example, field-specific CSI resource sets may be configured.

In a first implementation (which may be referred to as option 1), CSI report setting may be associated with only field-specific CSI resource sets. For example, a given CSI report setting maybe configured only for near-field or far-field, but not both.

In a second implementation (which may be referred to as option 2) CSI report setting may be associated with multiple CSI resource sets, wherein the different resource sets may be associated with near-field and/or far-field.

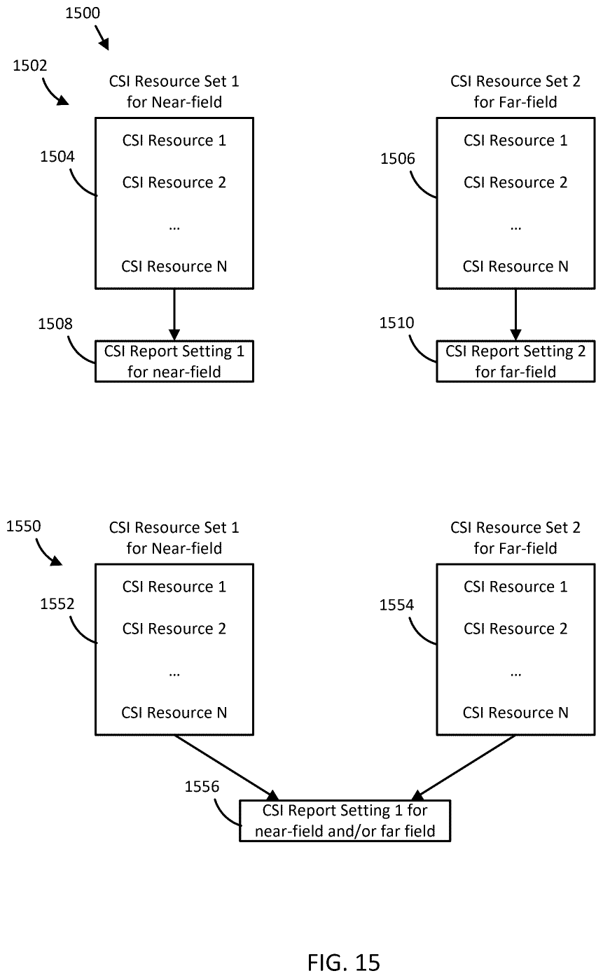

FIG. 15 illustrates example arrangements 1500 of the sixth approach in accordance with some embodiments. The arrangements 1500 include a first arrangement 1502 illustrating the first implementation of the first option of the sixth approach and a second arrangement 1550 illustrates the second implementation of the first option of the sixth approach.

The first arrangement 1502 includes a first CSI resource set 1504 for near-field operation and a second CSI resource set 1506 for far-field operation. The first arrangement 1502 includes CSI report settings corresponding to each of the near-field operation and the far-field operation. In particular, the first arrangement 1502 includes a first CSI report setting 1508 for near-field operation. The first CSI report setting 1508 may be utilized with the resources from the first CSI resource set 1504. The first arrangement 1502 further includes a second CSI report setting 1510 for far-field operation. The second CSI report setting 1510 may be utilized with the resources from the second CSI resource set 1506.

The second arrangement 1550 includes a first CSI resource set 1552 for near-field operation and a second CSI resource set 1554 for far-field operation. The second arrangement 1550 includes a CSI report setting that can be utilized for both CSI resource sets. In particular, the second arrangement 1550 includes a first CSI report setting 1556 for both near-field operation and far-field operation. The first CSI report setting 1556 may be utilized with the resources from the first CSI resource set 1552 and resources from the second CSI resource set 1554.

According to a second option of the sixth approach (which may be referred to as approach 6-2), a CSI resource set may contain multiple resources, where the resources may not be specific to near-field region or far-field region. For example, the field-specific CSI resource sets may not necessarily be configured. A same CSI resource set may be associated with a field-specific reporting. For example, one CSI report setting for near-field is associated with a given CSI resource set and another CSI report setting for far-field is associated with the same given CSI resource.

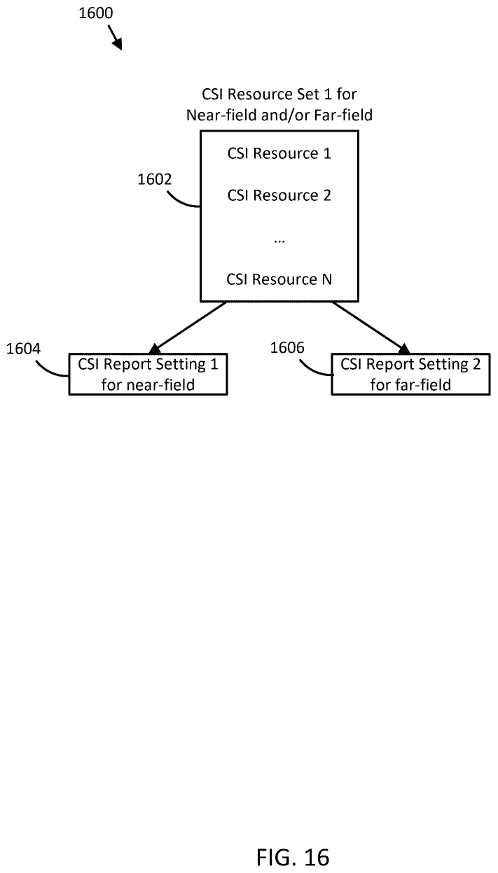

FIG. 16 illustrates an example arrangement 1600 of the second option of the sixth approach in accordance with some embodiments. In particular, the arrangement 1600 illustrates an example of a first CSI report setting for near-field operation and a second CSI report setting for far-field operation that may be utilized with a same CSI resource set.

The arrangement 1600 includes a CSI resource set 1602 for both near-field operation and far-field operation. In particular, the resources within the CSI resource set 1602 may be utilized for both near-field operation and far-field operation. The arrangement 1600 further includes CSI report settings corresponding to each of the near-field operation and the far-field operation. In particular, the arrangement 1600 includes a first CSI report setting 1604 for near-field operation. The first CSI report setting 1604 may be utilized with the resources from the CSI resource set 1602. The arrangement 1600 further includes a second CSI report setting 1606 for far-field operation. The second CSI report setting 1606 may also be utilized with the resources from the CSI resource set 1602.

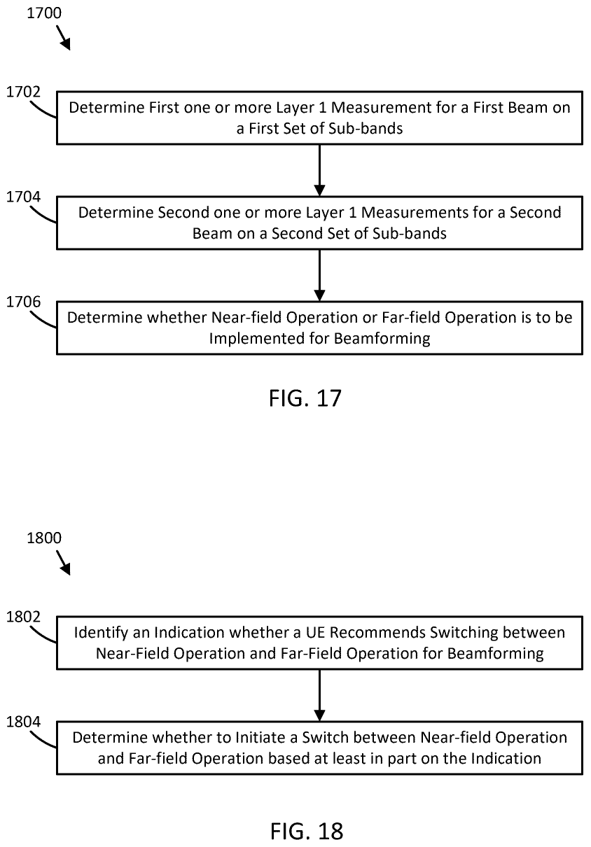

FIG. 17 illustrates an example procedure 1700 for determining whether near-field operation or far-field operation is to be implemented for beamforming in accordance with some embodiments. The procedure 1700 may be performed by a UE, such as the UE 104 (FIG. 1), the UE 106 (FIG. 1), and/or the UE 200 (FIG. 2).

The procedure 1700 may include determining first one or more layer 1 measurements for a first beam on a first set of sub-bands in 1702.

The procedure 1700 may include determining second one or more layer 1 measurements for a second beam on a second set of sub-bands in 1704.

The procedure 1700 may include determining whether near-field operation or far-field operation is to be implemented for beamforming based at least in part on a ratio of the second set of sub-bands to the first one or more layer 1 measurements on the first set of sub-bands in 1706.

In some embodiments, the first set of sub-bands may be middle sub-bands. Further, the first one or more layer 1 measurements for the first beam may include first one or more layer 1 reference signal received power (L1-RSRP) measurements, first one or more layer signal-to-interference-plus-noise ratio (L1-SINR) measurements, or first one or more layer 1 reference signal received quality (RSRQ) measurements. Further, the second one or more layer 1 measurements for the second beam include second one or more layer 1 reference signal received power (L1-RSRP) measurements, second one or more layer signal-to-interference-plus-noise ratio (L1-SINR) measurements, or second one or more layer 1 reference signal received quality (RSRQ) measurements in some embodiments.

In some embodiments, determining whether near-field operation or far-field operation is to be implemented may include determining whether the ratio exceeds a threshold. In some of these embodiments, determining whether near-field operation or far-field operation is to be implemented may include determining to switch from far-field operation to near-field operation based at least in part on the ratio being below the threshold for a at least a minimum configured duration. Further, determining whether near-field operation or far-field operation is to be implemented may include determining to switch from near-field operation to far-field operation based at least in part on the ratio being above the threshold for at least a minimum configured duration in some of these embodiments.

In some embodiments, determining whether near-field operation or far-field operation is to be implemented may include determining whether to switch between near-field operation and far-field operation. In these embodiments, the procedure 1700 may further include determining a value for binary information feedback based at least in part on determining whether to switch between near-field operation and far-field operation, or determining whether to report binary feedback on a configured uplink resource based at least in part on determining whether to switch between near-field operation and far-field operation.

In some embodiments, the procedure 1700 may include identifying an indication to switch between near-field operation and far-field operation. The indication may be provided via medium access control (MAC) control element (CE), downlink control information (DCI), or a combination of MAC CE and DCI.

In some embodiments, the procedure 1700 may include determining whether to switch between near-field operation and far-field operation based at least in part on a radio resource control (RRC) reconfiguration of transmission configuration indicator (TCI) states, a medium access control (MAC) control element (CE) activation of transmission TCI states, or a downlink control information (DCI) indication of a TCI state.

In some embodiments, the procedure 1700 may include identifying a radio resource control (RRC) configuration of a first set of transmission configuration indicator (TCI) states for near-field operation and a second set of TCI states for far-field operation. The procedure 1700 may further include identifying medium access control (MAC) control element (CE) activation a sub-set of the first set of TCI states or the second set of TCI states. Further, the procedure 1700 may include identifying downlink control information (DCI) indication of one or more TCI states from the sub-set, and implementing near-field operation or far-field operation in accordance with the one or more TCI states.

In some embodiments, the procedure 1700 may include identifying a configuration of one or more transmission configuration indicator (TCI) states for medium access control (MAC) control element (CE) activation. The one or more TCI states may be activated for near-field operation, far-field operation, or both near-field operation and far-field operation.

In some embodiments, the procedure 1700 may include identifying a channel state information (CSI) report setting configuration with a resource set configured for near-field operation or a resource set configured for far-field operation. The CSI report setting may be configured for one of near-field operation or far-field operation.

In some embodiments, the procedure 1700 may include identifying a channel state information (CSI) report setting configuration with a resource set having one or more resources. Each of the one or more resources may be configured for near-field operation or far-field operation. The CSI report setting may be configured for one of near-field operation or far-field operation.

In some embodiments, the procedure 1700 may include identifying a channel state information (CSI) report setting configuration with multiple CSI resource sets. The multiple CSI resource sets may be associated with near-field operation or far-field operation.

In some embodiments, the procedure 1700 may include identifying a channel state information (CSI) configuration having a CSI resource set with multiple resources. The CSI configuration may have a first CSI report setting for the CSI resource set for near-field operation and a second CSI report setting for the CSI resource set for far-field operation.

Any one or more of the operations in FIG. 17 may be performed in a different order than shown and/or one or more of the operations may be performed concurrently in embodiments. Further, it should be understood that one or more of the operations may be omitted from and/or one or more additional operations may be added to the procedure 1700 in other embodiments.

FIG. 18 illustrates an example procedure 1800 for determining whether to initiate a switch between near-field operation and far-field operation in accordance with some embodiments. The procedure 1800 may be performed by a base station, such as the base station 108 (FIG. 1) and/or the network device 300 (FIG. 3).

The procedure 1800 may include identifying an indication whether a user equipment (UE) recommends switching between near-field operation and far-field operation for beamforming in 1802. In some embodiments, the indication may comprise binary information, wherein a value of the binary information indicates whether the UE recommends switching between near-field operation and far-field operation. In other embodiments, identifying the indication may comprise determining whether a report is received on a configured uplink (UL) resource, wherein a presence or lack of presence of the report on the configured UL resource indicates whether the UE recommends switching between near-field operation and far-field operation.

The procedure 1800 may include determining whether to initiate a switch between near-field operation and far-field operation based at least in part on the indication in 1804.

In some embodiments, determining whether to initiate the switch includes determining to initiate the switch. In these embodiments, the procedure 1700 may further include generating a transmission to initiate the switch. The transmission may comprises a radio resource control (RRC) transmission that indicates the switch is to be initiated, a medium access control (MAC) control element (CE) transmission that indicates the switch is to be initiated, a downlink control information (DCI) transmission that indicates the switch is to be initiated, an RRC reconfiguration message for reconfiguration of transmission configuration information (TCI) states corresponding to the switch, an MAC CE activation message for activation of TCI states corresponding to the switch, or a DCI transmission that indicates a TCI state corresponding to the switch.

In some embodiments, the procedure 1800 may include configuring the UE with a first set of transmission configuration information (TCI) states corresponding to near-field operation and a second set of TCI states corresponding to far-field operation. Further, the procedure 1800 may include generating a medium access control (MAC) control element (CE) transmission to activate a sub-set of the first set of TCI states or the second set of TCI states based at least in part on near-field operation or far-field operation to be implemented by the UE.

Any one or more of the operations in FIG. 18 may be performed in a different order than shown and/or one or more of the operations may be performed concurrently in embodiments. Further, it should be understood that one or more of the operations may be omitted from and/or one or more additional operations may be added to the procedure 1800 in other embodiments.

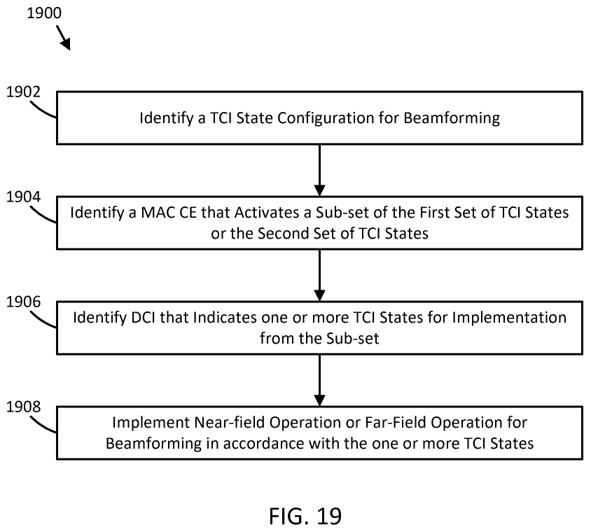

FIG. 19 illustrates an example procedure 1900 for implementing near-field operation or far-field operation for beamforming in accordance with some embodiments. The procedure 1900 may be performed by a UE, such as the UE 104 (FIG. 1), the UE 106 (FIG. 1), and/or the UE 200 (FIG. 2).

The procedure 1900 may include identifying a transmission configuration information (TCI) state configuration for beamforming in 1902. The TCI state configuration may include a first set of TCI states corresponding to near-field operation and a second set of TCI states corresponding to far-field operation.

The procedure 1900 may include identifying a medium access control (MAC) control element (CE) that activates a sub-set of the first set of TCI states or the second set of TCI states in 1904.

The procedure 1900 may include identifying downlink control information (DCI) that indicates one or more TCI states for implementation from the sub-set in 1906.

The procedure 1900 may include implementing near-field operation or far-field operation for beamforming in accordance with the one or more TCI states in 1908.

In some embodiments, the procedure 1900 may further include determining whether beamforming is to be switched between near-field operation and far-field operation based at least in part on a layer 1 (L1) reference signal received power (RSRP) of a sub-band. Further, the procedure 1900 may include providing an indication of whether beamforming is to be switched between near-field operation and far-field operation based at least in part on the determination whether beamforming is to be switched between near-field operation and far-field operation.

Any one or more of the operations in FIG. 19 may be performed in a different order than shown and/or one or more of the operations may be performed concurrently in embodiments. Further, it should be understood that one or more of the operations may be omitted from and/or one or more additional operations may be added to the procedure 1900 in other embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 may include a method comprising determining first one or more layer 1 measurements for a first beam on a first set of sub-bands, determining second one or more layer 1 measurements for a second beam on a second set of sub-bands, and determining whether near-field operation or far-field operation is to be implemented for beamforming based at least in part on a ratio of the second one or more layer 1 measurements on the second set of sub-bands to the first one or more layer 1 measurements on the first set of sub-bands.

Example 2 may include the method of example 1, wherein the first set of sub-bands are middle sub-bands, the first one or more layer 1 measurements for the first beam include first one or more layer 1 reference signal received power (L1-RSRP) measurements, first one or more layer signal-to-interference-plus-noise ratio (L1-SINR) measurements, or first one or more layer 1 reference signal received quality (RSRQ) measurements, and the second one or more layer 1 measurements for the second beam include second one or more layer 1 reference signal received power (L1-RSRP) measurements, second one or more layer signal-to-interference-plus-noise ratio (L1-SINR) measurements, or second one or more layer 1 reference signal received quality (RSRQ) measurements.

Example 3 may include the method of example 1, wherein determining whether near-field operation or far-field operation is to be implemented includes determining whether the ratio exceeds a threshold.

Example 4 may include the method of example 3, wherein determining whether near-field operation or far-field operation is to be implemented includes determining to switch from far-field operation to near-field operation based at least in part on the ratio being below the threshold for at least a minimum configured duration.

Example 5 may include the method of example 3, wherein determining whether near-field operation or far-field operation is to be implemented includes determining to switch from near-field operation to far-field operation based at least in part on the ratio being above the threshold for at least a minimum configured duration.

Example 6 may include the method of example 1, wherein determining whether near-field operation or far-field operation is to be implemented includes determining whether to switch between near-field operation and far-field operation, and wherein the method further comprises determining a value for binary information feedback based at least in part on determining whether to switch between near-field operation and far-field operation, or determining whether to report binary feedback on a configured uplink resource based at least in part on determining whether to switch between near-field operation and far-field operation.

Example 7 may include the method of example 1, further comprising identifying an indication to switch between near-field operation and far-field operation, the indication provided via medium access control (MAC) control element (CE), downlink control information (DCI), or a combination of MAC CE and DCI.

Example 8 may include the method of example 1, further comprising determining whether to switch between near-field operation and far-field operation based at least in part on a radio resource control (RRC) reconfiguration of transmission configuration indicator (TCI) states, a medium access control (MAC) control element (CE) activation of transmission TCI states, or a downlink control information (DCI) indication of a TCI state.

Example 9 may include the method of example 1, further comprising identifying a radio resource control (RRC) configuration of a first set of transmission configuration indicator (TCI) states for near-field operation and a second set of TCI states for far-field operation, identifying medium access control (MAC) control element (CE) activation of a sub-set of the first set of TCI states or the second set of TCI states, identifying downlink control information (DCI) indication of one or more TCI states from the sub-set, and implementing near-field operation or far-field operation in accordance with the one or more TCI states.

Example 10 may include the method of example 1, further comprising identifying a configuration of one or more transmission configuration indicator (TCI) states for medium access control (MAC) control element (CE) activation, the one or more TCI states to be activated for near-field operation, far-field operation, or both near-field operation and far-field operation.

Example 11 may include the method of example 1, further comprising identifying a channel state information (CSI) report setting configuration with a resource set configured for near-field operation or a resource set configured for far-field operation, wherein the CSI report setting is configured for one of near-field operation or far-field operation.

Example 12 may include the method of example 1, further comprising identifying a channel state information (CSI) report setting configuration with a resource set having one or more resources, each of the one or more resources configured for near-field operation or far-field operation, wherein the CSI report setting is configured for one of near-field operation or far-field operation.

Example 13 may include the method of example 1, further comprising identifying a channel state information (CSI) report setting configuration with multiple CSI resource sets, wherein the multiple CSI resource sets are associated with near-field operation or far-field operation.

Example 14 may include the method of example 1, further comprising identifying a channel state information (CSI) configuration having a CSI resource set with multiple resources, the CSI configuration having a first CSI report setting for the CSI resource set for near-field operation and a second CSI report setting for the CSI resource set for far-field operation.

Example 15 may include a method comprising identifying an indication whether a user equipment (UE) recommends switching between near-field operation and far-field operation for beamforming, and determining whether to initiate a switch between near-field operation and far-field operation based at least in part on the indication.

Example 16 may include the method of example 15, wherein the indication comprises binary information, and wherein a value of the binary information indicates whether the UE recommends switching between near-field operation and far-field operation.

Example 17 may include the method of example 15, wherein identifying the indication comprises determining whether a report is received on a configured uplink (UL) resource, and wherein a presence or lack of presence of the report on the configured UL resource indicates whether the UE recommends switching between near-field operation and far-field operation.

Example 18 may include the method of example 15, wherein determining whether to initiate the switch includes determining to initiate the switch, and wherein the method further comprises generating a transmission to initiate the switch.

Example 19 may include the method of example 18, wherein the transmission comprises a radio resource control (RRC) transmission that indicates the switch is to be initiated, a medium access control (MAC) control element (CE) transmission that indicates the switch is to be initiated, a downlink control information (DCI) transmission that indicates the switch is to be initiated, an RRC reconfiguration message for reconfiguration of transmission configuration information (TCI) states corresponding to the switch, an MAC CE activation message for activation of TCI states corresponding to the switch, or a DCI transmission that indicates a TCI state corresponding to the switch.

Example 20 may include the method of example 15, further comprising configuring the UE with a first set of transmission configuration information (TCI) states corresponding to near-field operation and a second set of TCI states corresponding to far-field operation, and generating a medium access control (MAC) control element (CE) transmission to activate a sub-set of the first set of TCI states or the second set of TCI states based at least in part on near-field operation or far-field operation to be implemented by the UE.

Example 21 may include a method comprising identifying a transmission configuration information (TCI) state configuration for beamforming, the TCI state configuration including a first set of TCI states corresponding to near-field operation and a second set of TCI states corresponding to far-field operation, identifying a medium access control (MAC) control element (CE) that activates a sub-set of the first set of TCI states or the second set of TCI states, identifying downlink control information (DCI) that indicates one or more TCI states for implementation from the sub-set, and implementing near-field operation or far-field operation for beamforming in accordance with the one or more TCI states.

Example 22 may include the method of example 21, further comprising determining whether beamforming is to be switched between near-field operation and far-field operation based at least in part on a layer 1 (L1) reference signal received power (RSRP) of a sub-band, and providing an indication of whether beamforming is to be switched between near-field operation and far-field operation based at least in part on the determination whether beamforming is to be switched between near-field operation and far-field operation.

Example 23 may include an apparatus comprising means to perform one or more elements of a method described in or related to any of examples 1-22, or any other method or process described herein.

Example 24 may include one or more non-transitory computer-readable media comprising instructions to cause an electronic device, upon execution of the instructions by one or more processors of the electronic device, to perform one or more elements of a method described in or related to any of examples 1-22, or any other method or process described herein.

Example 25 may include an apparatus comprising logic, modules, or circuitry to perform one or more elements of a method described in or related to any of examples 1-22, or any other method or process described herein.

Example 26 may include a method, technique, or process as described in or related to any of examples 1-22, or portions or parts thereof.

Example 27 may include an apparatus comprising: one or more processors and one or more computer-readable media comprising instructions that, when executed by the one or more processors, cause the one or more processors to perform the method, techniques, or process as described in or related to any of examples 1-22, or portions thereof.

Example 28 may include a signal as described in or related to any of examples 1-22, or portions or parts thereof.

Example 29 may include a datagram, information element, packet, frame, segment, PDU, or message as described in or related to any of examples 1-22, or portions or parts thereof, or otherwise described in the present disclosure.

Example 30 may include a signal encoded with data as described in or related to any of examples 1-22, or portions or parts thereof, or otherwise described in the present disclosure.

Example 31 may include a signal encoded with a datagram, IE, packet, frame, segment, PDU, or message as described in or related to any of examples 1-22, or portions or parts thereof, or otherwise described in the present disclosure.

Example 32 may include an electromagnetic signal carrying computer-readable instructions, wherein execution of the computer-readable instructions by one or more processors is to cause the one or more processors to perform the method, techniques, or process as described in or related to any of examples 1-22, or portions thereof.

Example 33 may include a computer program comprising instructions, wherein execution of the program by a processing element is to cause the processing element to carry out the method, techniques, or process as described in or related to any of examples 1-22, or portions thereof.

Example 34 may include a signal in a wireless network as shown and described herein.

Example 35 may include a method of communicating in a wireless network as shown and described herein.

Example 36 may include a system for providing wireless communication as shown and described herein.

Example 37 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
determining first at least one layer 1 measurement for a first beam on a first set of sub-bands;
determining second at least one layer 1 measurement for a second beam on a second set of sub-bands; and
determining whether near-field operation or far-field operation is to be implemented for beamforming based at least in part on a ratio of the second at least one layer 1 measurement on the second set of sub-bands to the first at least one layer 1 measurement on the first set of sub-bands.

2. The method of claim 1, wherein:
the first set of sub-bands are middle sub-bands;
the first at least one layer 1 measurement for the first beam includes first at least one layer 1 reference signal received power (L1-RSRP) measurement, first at least one layer 1 signal-to-interference-plus-noise ratio (L1-SINR) measurement, or first at least one layer 1 reference signal received quality (RSRQ) measurement; and
the second at least one layer 1 measurement for the second beam includes second at least one layer 1 reference signal received power (L1-RSRP) measurement, second at least one layer 1 signal-to-interference-plus-noise ratio (L1-SINR) measurement, or second at least one layer 1 reference signal received quality (RSRQ) measurement.

3. The method of claim 1, wherein determining whether near-field operation or far-field operation is to be implemented includes determining whether the ratio exceeds a threshold.

4. The method of claim 3, wherein determining whether near-field operation or far-field operation is to be implemented includes determining to switch from far-field operation to near-field operation based at least in part on the ratio being below the threshold for at least a minimum configured duration.

5. The method of claim 3, wherein determining whether near-field operation or far-field operation is to be implemented includes determining to switch from near-field operation to far-field operation based at least in part on the ratio being above the threshold for at least a minimum configured duration.

6. The method of claim 1, wherein determining whether near-field operation or far-field operation is to be implemented includes determining whether to switch between near-field operation and far-field operation, and wherein the method further comprises:
determining a value for binary information feedback based at least in part on determining whether to switch between near-field operation and far-field operation; or
determining whether to report binary feedback on a configured uplink resource based at least in part on determining whether to switch between near-field operation and far-field operation.

7. The method of claim 1, further comprising:
identifying an indication to switch between near-field operation and far-field operation, the indication provided via medium access control (MAC) control element (CE), downlink control information (DCI), or a combination of MAC CE and DCI.

8. The method of claim 1, further comprising:
determining whether to switch between near-field operation and far-field operation based at least in part on:
a radio resource control (RRC) reconfiguration of transmission configuration indicator (TCI) states;
a medium access control (MAC) control element (CE) activation of transmission TCI states; or
a downlink control information (DCI) indication of a TCI state.

9. The method of claim 1, further comprising:
identifying a radio resource control (RRC) configuration of a first set of transmission configuration indicator (TCI) states for near-field operation and a second set of TCI states for far-field operation;
identifying medium access control (MAC) control element (CE) activation of a sub-set of the first set of TCI states or the second set of TCI states;
identifying downlink control information (DCI) indication of at least one TCI state from the sub-set; and
implementing near-field operation or far-field operation in accordance with the at least one TCI state.

10. The method of claim 1, further comprising:
identifying a configuration of at least one transmission configuration indicator (TCI) state for medium access control (MAC) control element (CE) activation, the at least one TCI state to be activated for:
near-field operation;
far-field operation; or
both near-field operation and far-field operation.

11. The method of claim 1, further comprising:
identifying a channel state information (CSI) report setting configuration with a resource set configured for near-field operation or a resource set configured for far-field operation, wherein the CSI report setting is configured for one of near-field operation or far-field operation.

12. The method of claim 1, further comprising:
identifying a channel state information (CSI) report setting configuration with a resource set having at least one resource, each of the at least one resources configure for near-field operation or far-field operation, wherein the CSI report setting is configured for one of near-field operation or far-field operation.

13. A method comprising:
identifying an indication whether a user equipment (UE) recommends switching between near-field operation and far-field operation for beamforming; and
determining whether to initiate a switch between near-field operation and far-field operation based at least in part on the indication.

14. The method of claim 13, wherein the indication comprises binary information, and wherein a value of the binary information indicates whether the UE recommends switching between near-field operation and far-field operation.

15. The method of claim 13, wherein identifying the indication comprises determining whether a report is received on a configured uplink (UL) resource, and wherein a presence or lack of presence of the report on the configured UL resource indicates whether the UE recommends switching between near-field operation and far-field operation.

16. The method of claim 13, wherein determining whether to initiate the switch includes determining to initiate the switch, and wherein the method further comprises:
generating a transmission to initiate the switch.

17. The method of claim 16, wherein the transmission comprises:
a radio resource control (RRC) transmission that indicates the switch is to be initiated;
a medium access control (MAC) control element (CE) transmission that indicates the switch is to be initiated;
a downlink control information (DCI) transmission that indicates the switch is to be initiated;
an RRC reconfiguration message for reconfiguration of transmission configuration information (TCI) states corresponding to the switch;
an MAC CE activation message for activation of TCI states corresponding to the switch; or
a DCI transmission that indicates a TCI state corresponding to the switch.

18. The method of claim 13, further comprising:
configuring the UE with a first set of transmission configuration information (TCI) states corresponding to near-field operation and a second set of TCI states corresponding to far-field operation; and
generating a medium access control (MAC) control element (CE) transmission to activate a sub-set of the first set of TCI states or the second set of TCI states based at least in part on near-field operation or far-field operation to be implemented by the UE.

19. An apparatus comprising:
processing circuitry to:
identify a transmission configuration information (TCI) state configuration for beamforming, the TCI state configuration including a first set of TCI states corresponding to near-field operation and a second set of TCI states corresponding to far-field operation;
identify a medium access control (MAC) control element (CE) that activates a sub-set of the first set of TCI states or the second set of TCI states;
identify downlink control information (DCI) that indicates at least one TCI state for implementation from the sub-set; and
implement near-field operation or far-field operation for beamforming in accordance with the at least one TCI state; and
interface circuitry coupled with the processing circuitry, the interface circuitry to enable communication.

20. The apparatus of claim 19, wherein the processing circuitry is further to:
determine whether beamforming is to be switched between near-field operation and far-field operation based at least in part on a layer 1 (L1) reference signal received power (RSRP) of a sub-band; and
provide an indication of whether beamforming is to be switched between near-field operation and far-field operation based at least in part on the determination whether beamforming is to be switched between near-field operation and far-field operation.
